(19) United States
(12) Patent Application Publication
(10) Pub. No.: US 2018/0259159 A1
(43) Pub. Date: Sep. 13, 2018

(54) ROTARY APERTURE SYSTEM FOR USE IN A LIGHTING SYSTEM

(71) Applicant: Richard LOGOTHETIS, Sugar Loaf, NY (US)

(72) Inventor: Richard LOGOTHETIS, Sugar Loaf, NY (US)

(21) Appl. No.: 15/758,441

(22) PCT Filed: Oct. 4, 2016
(86) PCT No.: PCT/US2016/055270

§ 371 Date: Mar. 8, 2018

Related U.S. Application Data
(60) Provisional application No. 62/237,116, filed on Oct. 5, 2015.

(51) Int. Cl. F21V 11/00; F21V 14/08

(52) U.S. Cl. CPC F21V 11/00; F21W 2131/406; F21V 14/08

(57) ABSTRACT

A lighting system, having a housing including an opening; a lamp configured to emit a light beam having a first width through the opening; and an adjustable iris system configured to define the first dimension of the light beam, the iris system having a first roller having a generally cylindrical shape having a first radial volute shaped groove defined in a lateral surface of the first roller; and a second roller having generally cylindrical shape having a second radial volute shaped groove defined in a lateral surface of the second roller, wherein the first and second shaped grooves define an iris aperture therebetween when aligned, wherein the first and second rollers are rotatable relative to one another, and wherein the defined iris aperture space has a second dimension that changes in response to rotation of the first and second rollers relative to one another, the first dimension corresponding to the second dimension when the light beam is emitted by the lamp.

### CROSS REFERENCE TO RELATED APPLICATION

This application relates to and claims priority from U.S. Prov. Ser. No. 62/237,116 filed Oct. 5, 2015, the entire contents of which are incorporated herein fully by reference.

### FIGURE SELECTED FOR PUBLICATION

FIG. 7.

### BACKGROUND OF THE INVENTION

### Technical Field

The present invention relates generally to lighting equipment, and more particularly to an adjustable aperture or iris through which a light beam is shone for adjusting the size and/or intensity of the light beam emitted by the lighting equipment.

### Description of the Related Art

Stage lighting is used to perform a variety of functions especially for entertainment purposes in the performing arts such as dance and theatre. A variety of sage lighting equipment has been devised, as detailed for example, in U.S. Pat. Pub. No. 2013/0200795 (Clark), which is incorporated by reference herein in its entirety.

For example, one popular piece of stage lighting equipment is known as a followspot or a spotlight, which allows a user to project a bright beam of light onto a performance space to highlight a specific object or individual. The spotlight may include a lens which may be manually focused to adjust the size, intensity, and/or angle of the beam of light through a series of optical lenses and gate-shutters. For example, a prior art spotlight, as shown in FIG. 1, a spotlight 100 includes a fan/vent 105, a dowser assembly 110, a damper 115, and iris controller 120, a boomerang 125, a focus knob/handle 130, a tilt adjustment 135, a pan adjustment 140, a yoke 145, a base 150, a movement handle 155, leveling jacks 160, and a lamp-house assembly 200.

The fan/vent 105 is preferably a ventilation fan that cools the lamp, which operates at a very high temperature. It will be recognized that such lamp temperatures may exceed 1,000° F., and may even exceed 1,000-2,000° C. (Celsius) or more depending upon the type of intense light or laser source used. The dowser assembly 110 is generally a device mechanism that allows a user to mechanically “dim” the emitted light of the spotlight 100, and is usually a handle on the back or side of the spotlight 100. The damper 115 (also known as the chopper or shutter) is typically constructed as two shutters that chop the light up and down. The iris 120 is typically a mechanism that makes the circle of light smaller or bigger as desired using a concentric leaf-shutter, with a series of overlapping metal fan-leafs. Generally, the boomerang 125 is the section either located at the right, front, or middle of the spotlight that has six or more handles for color filters; wherein the handles pull down and click the filters into place. The focus knob/handle 130 is the knob or handle that adjust a reflector to provide a sharp or soft focus. The tilt adjustment 135 is typically an adjustment knob that allows the spotlight to move up and down, and is typically found on the yoke 145. The pan adjustment 140 is generally an adjustment that allows the spotlight 100 to swivel left and right, and is usually found on the base 150. Like other traditional lighting fixtures, the yoke 145 is typically the “U-shaped” structure that is directly connected to the fixture. The base 150, which may be a separate component of the spotlight, is preferably the structure that supports the unit by connecting to the yoke 145, and most often includes casters. The movement handle 155 is generally the handles (typically in the back and side of the spotlight 100), which allow either up-down and/or right-left movements of the spotlight 100. Generally, the leveling jacks 160 are components that allow the spotlight to be lifted off the base's castors and provide fine leveling adjustments.

Conventional irises for controlling the light that is output do not have a continuously variable aperture but instead provide a limited number of sizes for the aperture through which the light is directed. Further, conventional irises may not maintain a fully circular shape when being adjusted. Moreover, as a particular detriment to the conventional arts, the high operating temperatures of the spotlight (up to and more than 1,500° C. to 2,000° C. (Celcius) may impair the operation of conventional irises impairing the operation of the iris as the metal from which the iris expands and/or contracts due to the temperature changes. Indeed, at such temperatures, conventional iris materials often melt, degrade, distort, and fully fail to control the size and shape of emitted light in a manner which is required to function at such temperatures and which make it impossible to provide a consistently shaped iris orifice without damage and degradation to the equipment

Thus, there is a continuing need for new and improved lighting equipment that address at least one of the needs noted above.

### ASPECTS AND SUMMARY OF THE INVENTION

In an embodiment of the present disclosure, an adjustable iris system may comprise a first roller having a generally cylindrical shape and a radial volute or first radial volute shaped groove defined in a lateral surface of the first roller; and a second roller in apposition with respect to the first roller. The second roller may have a generally cylindrical shape and may include a second radial volute or radial volute shaped groove defined in a lateral surface of the second roller. The first and second rollers may be rotatable relative to one another. The first and second rollers may be positioned relative to one another such to define a space between the first and second radial volute or tear shaped grooves that is symmetrical with respect a longitudinally extending axis between the first and second rollers, the space having a generally circular shape defining a bounded optical diameter that corresponds to a relative rotatable position of the first and second rollers with respect to one another and an incident beam of light.

A lighting system may include a housing including an opening; a lamp configured to emit a light beam having a first width through the opening; and an adjustable iris system configured to define the first width of the light beam, the iris system comprising: a first roller having a generally cylindrical shape having a radial volute or first radial volute shaped groove defined in a lateral surface of the first roller; and a second roller having generally cylindrical shape having a second radial volute or tear shaped groove defined in a lateral surface of the second roller. The first and second radial volute shaped grooves define a space therebetween along a portion of the wrap angle of each radial volute on each respective roller, wherein the first and second rollers are rotatable relative to one another, and wherein the space has an area that changes in response to rotation of the first and second rollers relative to one another and the wrap angle of respective first and second radial volutes on each first and second roller when the light beam is emitted by the lamp.

A lighting kit may comprise (a) a housing for mounting an adjustable iris system, the housing including a first surface and a second opposing surface; and (a) an adjustable iris system, comprising: a first roller having a generally cylindrical radial volute shape with volute outlet that is greater than a volute inlet understood as a radial volute shaped groove defined in a lateral surface of the first roller; and a second roller in apposition with respect to the first roller, the second roller having a generally cylindrical radial volute shape with a volute outlet that is greater than a volute inlet understood as a second radial volute shaped groove defined in a lateral surface of the second roller. The first and second rollers may be in an urged spring contact with each other and rotatable relative to one another using an interference gearing system, and the first and second rollers may be positioned relative to one another such to define a space between the first and second radial volute shaped grooves that is symmetrical with respect a longitudinally extending axis between the first and second rollers, the space having a circular shape having a diameter that corresponds to a relative rotatable position of the first and second rollers with respect to one another. The first roller may be mountable widthwise between the first and second surfaces of the housing, the first roller being fixed with respect to a height dimension of the housing, and wherein the second roller is mountable widthwise between the first and second surfaces of the housing, the second roller being movable along the height dimension of the housing and being biased toward the first roller. It will be understood that either one or both of the first and second rollers may be slidably adjustable relative to each other to allow for thermal expansion during a use of the proposed system while maintaining a continuous contact therewith.

Another aspect of the present invention provides an adjustable iris system, comprising; a first roller having a generally cylindrical shape and a first radial volute shaped groove defined along a portion of an outer surface of the first roller; and a second roller in apposition with respect to the first roller, the second roller having a generally cylindrical shape and a second radial volute shaped groove defined along a portion of an outer surface of the second roller; the first and second rollers are rotatable relative to one another about respective first and second rotational axes; at least one of the first and second rotational axes of being adjustable relative to the other of the first and second rotational axes so that a distance between the first and second rotational axes may increase during a use while the respective rotational axes remain in parallel; and wherein the first and second rollers are positioned relative to one another such to define an adjustable space therebetween respective of the first and second radial volute shaped grooves that changes from an initial minimum radius (rₘᵢₙ) to a maximum radius (rₘₐₓ) along a respective first and a second wrap angles for each respective first and second radial volute groove about respective the first and second rotational axes of the first and second rollers, the adjustable space having a generally circular shape having a free radius that corresponds to a relative rotatable position of the first and second rollers with respect to one another and an inner cross-sectional radius of each respective the first and second radial volute grooves.

According to another alternative embodiment of the present invention, there is a lighting kit, comprising; a housing for mounting an adjustable iris system, the housing including a first support surface and a second opposing support surface; and the adjustable iris system, comprising; a first roller having a generally cylindrical shape and a first radial volute shaped groove defined in a lateral surface of the first roller having a first wrap angle about the first roller; and a second roller in apposition with respect to the first roller, the second roller having a generally cylindrical shape and a second radial volute shaped groove defined in a lateral surface of the second roller and having a second wrap angle about the second roller, the first and second rollers are rotatable relative to one another, wherein the first and second rollers are positioned relative to one another in the housing and define a space therebetween the first and second radial volute shaped grooves that is symmetrical with respect a first rotational axis of the first roller and a second rotational axis of the second roller, the space defining circular aperture shape having a diameter that corresponds to a relative rotatable position of the first and second rollers with respect to one another, and wherein the first roller is mountable widthwise between the first and second support surfaces of the housing, the first roller being fixed with respect to a height dimension of the housing, and wherein the second roller is mountable widthwise between the first and second support surfaces of the housing, the second roller being movable along the height dimension of the housing and being biased toward the first roller during a use thereof.

According to another aspect of the present invention, there is provided, an adjustable aperture system for use in a lighting system, comprising; an aperture adjustment support having a first support member and a second support member; the first and second support members opposing each other and defining a space therebetween; a first roller having a generally cylindrical shape and a first radial volute groove defined in a lateral surface of the first roller; and a second roller in apposition with respect to the first roller, the second roller having a generally cylindrical shape and a second volute groove defined in a lateral surface of the second roller; wherein the first and second rollers are rotatable relative to one another, and wherein the first and second rollers are positioned relative to one another such to define a space between the first and second radial volute grooves that is symmetrical with respect a longitudinally extending axis between the first and second rollers, the space having a circular shape defining a diameter that corresponds to a relative rotatable position of the first and second rollers with respect to one another.

The above and other aspects, features and advantages of the present disclosure will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a perspective view of a prior art spotlight;

FIG. 2 is a perspective view of a spotlight in accordance with the present disclosure;

FIG. 3 is a front cross-sectional view of the spotlight of FIG. 2;

FIG. 4 is a see-through side view of the spotlight of FIG. 2;

FIG. 5 is a back view of a rotary iris system in accordance with the present disclosure;

FIG. 6 is a front close-up view of the rotary iris system of FIG. 5 as viewed through an opening in the support surface noting the radial volute grooves;

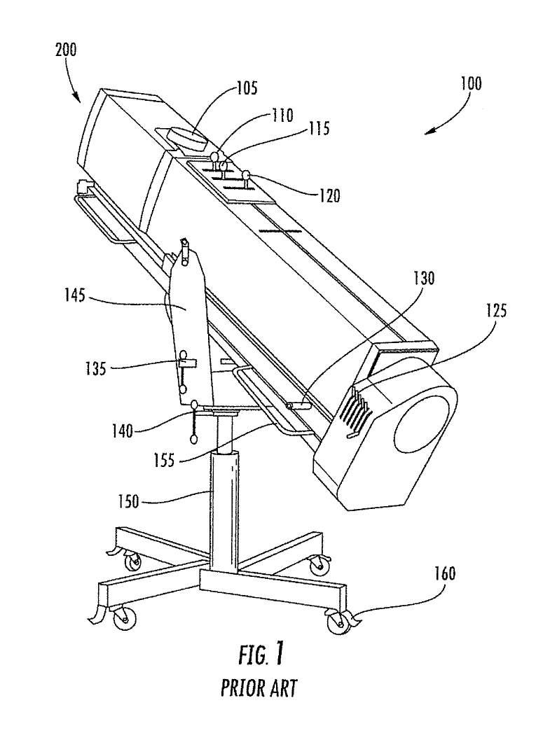

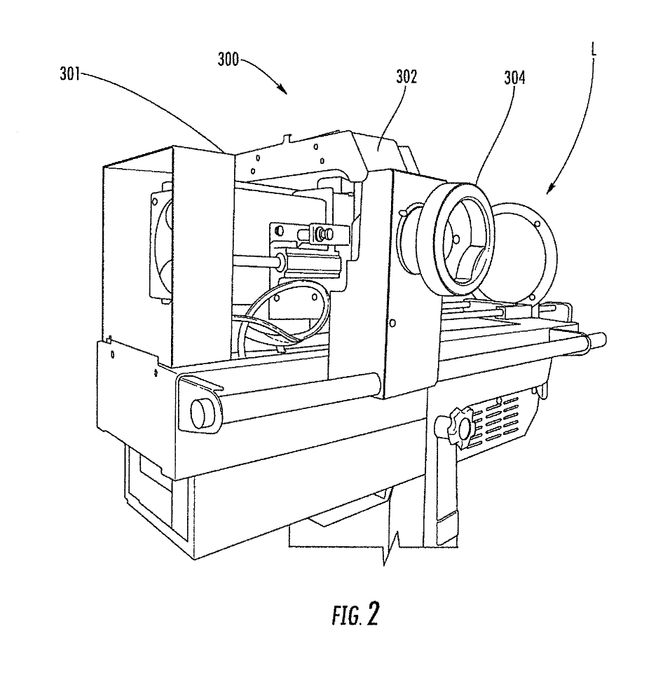

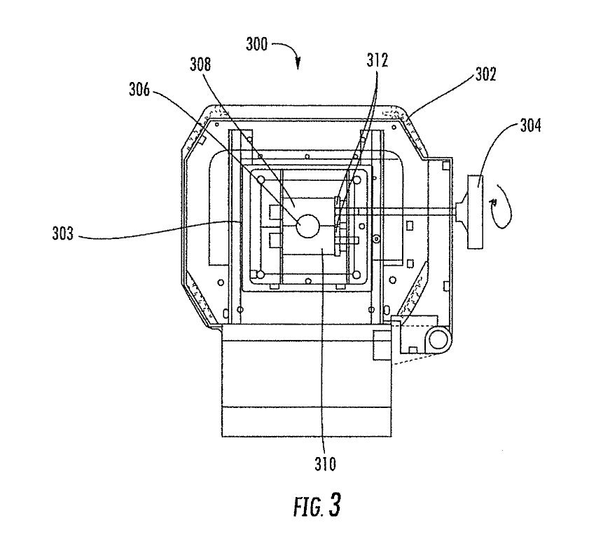

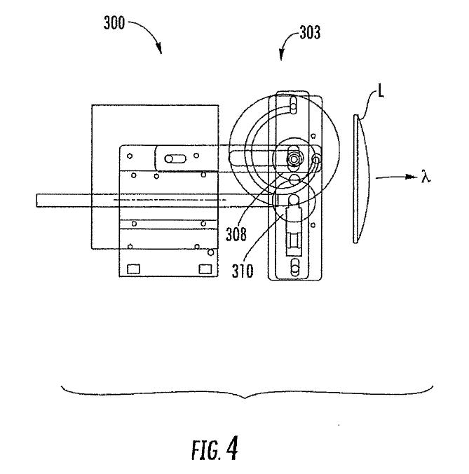

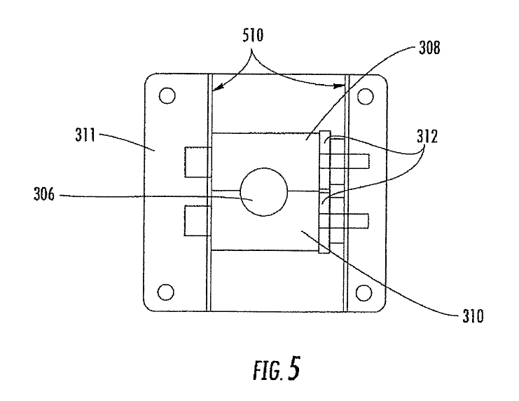

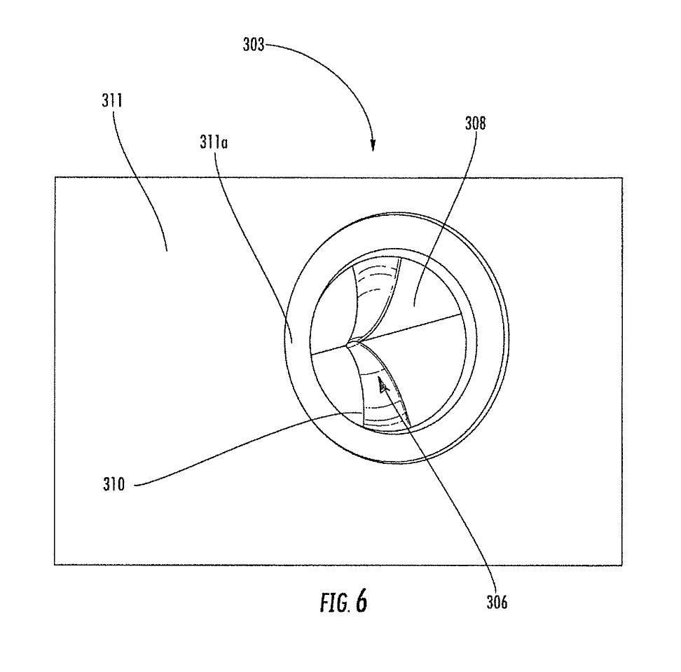

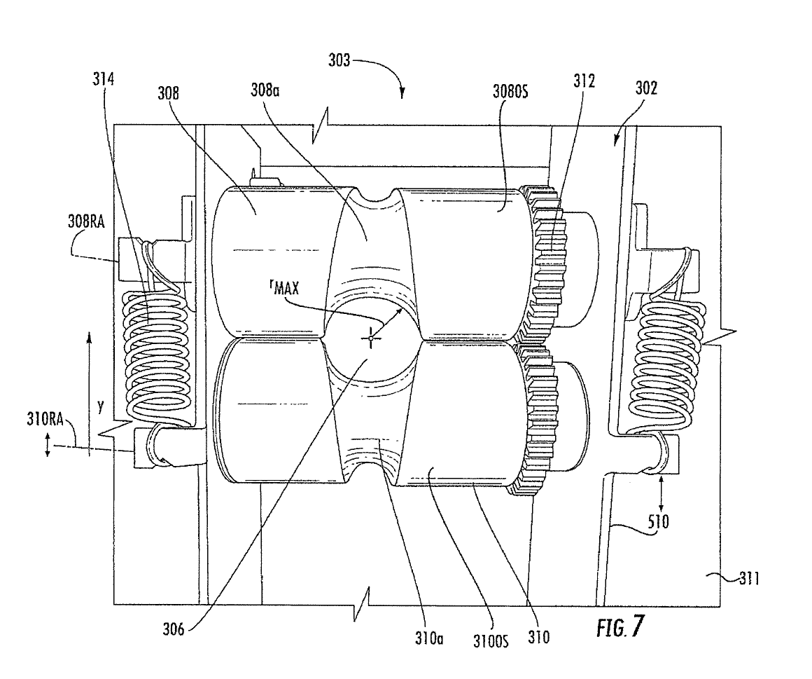

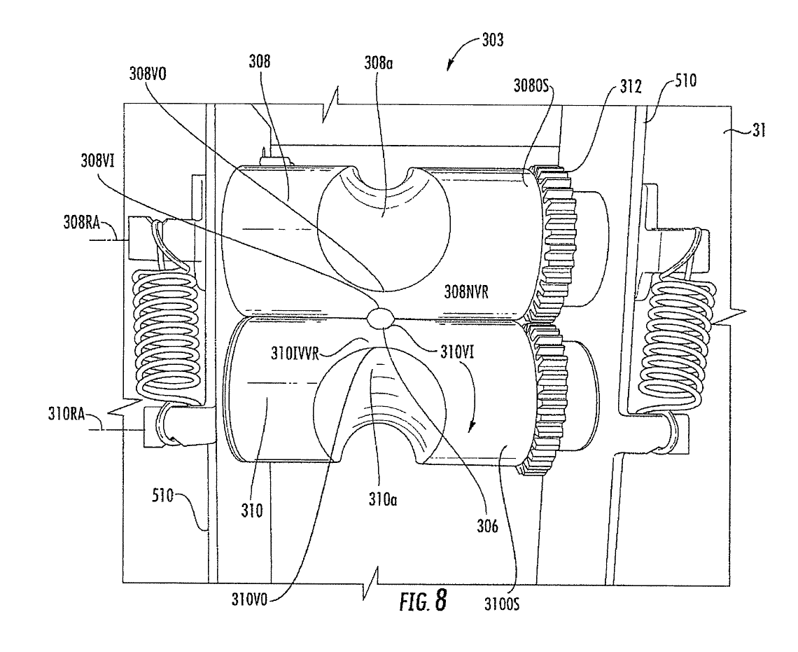

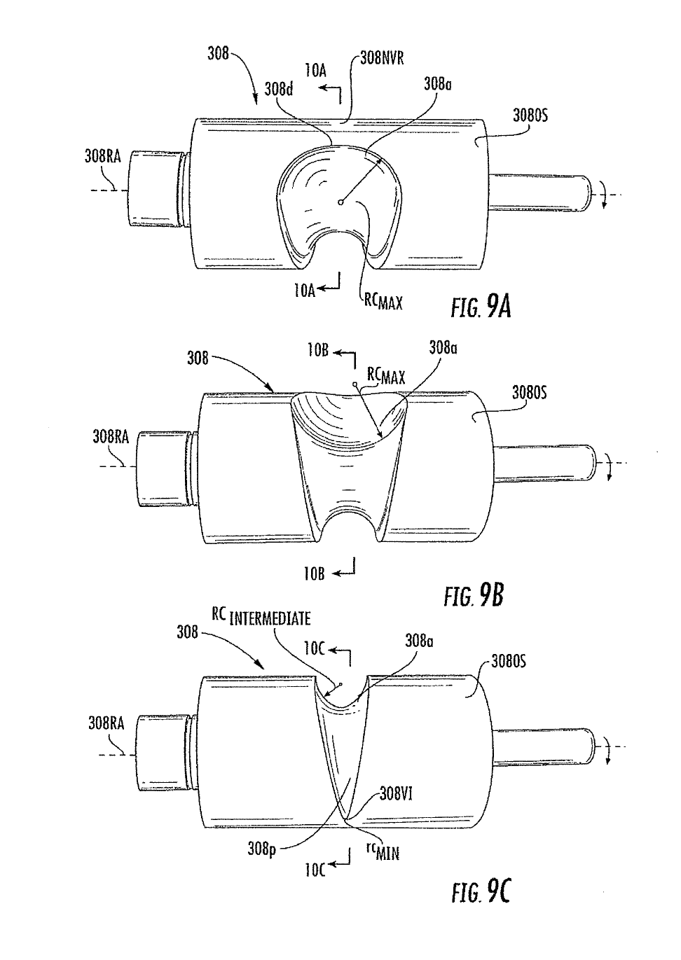

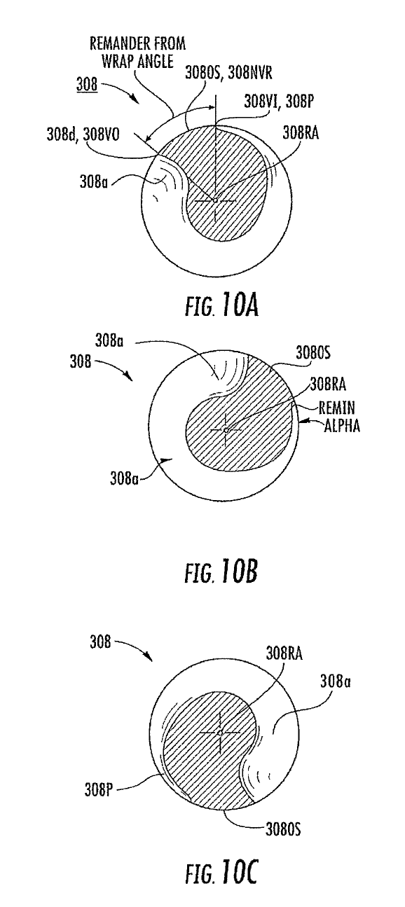

FIG. 7 is a rear perspective view of the rotary iris system of FIG. 5 shown in a first condition with a widely open iris;

FIG. 8 is a rear perspective view of the rotary iris system of FIG. 5 shown in a second condition with a narrowed iris; and

FIGS. 9A-9C are perspective views of a roller of the rotary iris system of FIG. 5 shown rotated to various positions relative to a radial volute position on an exemplary roller.

FIGS. 10A-10C are cross-sectional views of the radial volute groves along the wrap angles of each respective roller in respective FIGS. 9A-9C noting the wrap angle increasing as the radial volute progresses about the outer diameter of the roller and increases in depth.

### DETAILED DESCRIPTION OF THE PREFERRED EMBODIMENTS

As required, a detailed illustrative embodiment(s) of the present disclosure are disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention.

Reference will now be made in detail to several embodiments of the disclosure that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

Referring to FIGS. 2-9C, a spotlight system in accordance with the present disclosure is described herein. To avoid obscuring an understanding of the present invention, well-known structures have not been described in detail.

As shown in FIG. 2, a spotlight system 300 may include a housing 302 which may house a lamp-house assembly 301. The lamp-house assembly 301 may be substantially similar to the lamp-house assembly 200 described hereinabove with reference to U.S. Pat. Pub. No. 2013/0200795, the contents of which are fully incorporated herein by reference. The lamp-house assembly 301 may include a light source that directs a light beam toward and through a lens L.

With reference to FIGS. 3-9C, an iris adjustment system 303 of the spotlight system 300 is described. A housing 302 may include an adjustment mechanism 304 (e.g., an iris adjustment knob) rotatably mounted thereon, which may be rotated to adjust an iris or an aperture 306 through which the light beam emanating from the light source of the lamp-house assembly 301 is directed. The adjustment knob 304 may be operatively coupled to either roller, but is shown operatively coupled to a first roller 308 which may be generally cylindrically shaped. The first roller 308 may operatively engage a second roller 310. The iris adjustment system 303 may include a generally opaque surface 311 including an opening 311a formed therein such that light seepage is avoided between rollers 308, 310 and only light emanating from the iris opening 306 exits toward the lens L.

First and second rollers 308 and 310, each with an outer surface 308OS, 310OS may be generally aligned with one another along their longitudinal rotational axes such that their rotational axes 308RA and 310RA are in parallel. It will be understood that for the function of iris adjustment system 303 it is not necessary that the rotational axes be in parallel with surface 311, although that is conveniently shown here with securement in a bracket member 510 allowing engagement and rotation during use as will be described. Gears 312, 312 disposed at ends of the first and second rollers 308, 310 may engage one another such that as the knob 304, in controlling communication with either rotational axis 308RA or 310RA is rotated, which causes a corresponding rotation of the first roller 308, the second roller 310 in contact with the first roller 308 correspondingly rotates in cooperation. As the first and second rollers 308, 310 rotate relative to one another, respective radial volute grooves 308a, 310a formed in each of the first and second rollers 308, 310 define an iris 306 therebetween having a circular shape and dimension that changes in radius r in response to the rotation of the rollers 308, 310, such that it will be understood that radius r may extend from a zero radius r_{zero} (when outer surfaces 308OS and 310OS, are in direct contact and there is no opening (in mutual contact at respective non-volute regions 308NYR, 310NVR between respective volute inlets VIs and volute outlets VOs) and a maximum radius rₘₐₓ (when a first roller volute outlet 308VO is radially aligned with a second roller volute outlet 310VO (see FIG. 7) creating a maximum radius (rₘₐₓ)). Each roller 308, 310 having a radial volute or groove 308a, 310a, will be understood to have a respective initial volute inlet 308VI, 310VI (with a corresponding rₘᵢₙ in radial alignment) and a volute outlet 308VO, 310VI (with a corresponding rₘₐₓ when in radial alignment), and a region therebetween designated as a non-volute region 308NVR, 310NVR which is the outer surface 308OS, 310OS of each roller.

The rollers 308, 310 may be formed from a variety of materials including high temperature steel, steal alloys (such as Inconel® and HasteHoy® and others), cobalt, ceramics, alumina, and/or sapphire, such that their thermal durability is sufficient to eliminate degradation, spalling, brittle fracture, and sagging at temperatures up to and including 1,750° C. (Celsius).

The first and second rollers 308 and 310 are substantially similar to one another and are generally symmetrical with respect to one another when positioned against one another along their longitudinal axes, respectively 308RA and 310RA. The rollers 308, 310 may be rotatably mounted within the housing 302. One of the first and second rollers 308, 310 may be fixedly mounted with respect to a vertical direction axis y (See FIG. 7) of the housing 302 and support surface 311, and the other of the first and second rollers 308, 310 (or both) may be axially movable within a relatively small distance with respect to the vertical direction axis y such that the first and second rollers 308, 310 are movable relative to one another so as to continue in urged-contact therebetween despite changes in an external diameter (DIAₒᵤₜₑᵣ) of 308OS, 310OS during thermal expansion and contractions (see arrows in FIG. 7 noting adjustment of roller 310). It will be understood, that the housing 302 and bracket members 510, 510 include a slot rolling (not shown) so as to accommodate a shifting of the roller axis 310RA of roller 310 along the direction y.

Respective springs 314, 314 may bias the first and second rollers 308, 310 toward one another, but alternative urging means for maintaining a secure alignment but an shift in position may be used without departing from the scope of the present invention. By allowing the first and second rollers 308, 310 to move relative to one another, expansion/compression due to temperature changes of the materials forming the rollers 308, 310 may be accommodated.

As shown in FIG. 7, the iris aperture 306 has a generally circular shape having a relatively larger diameter (here a maximum radius than that shown in FIG. 8 (which shows an intermediate radius r_{intermedus} for example when rollers 308, 311 meet at respective locations Alpha (FIG. 10B shows Alpha on roller 308 but a similar location on roller 310 is understood)). The size of the diameter of the iris aperture 306 continuously changes along the radial volute grooves 308a, 310a, as shown from among a relatively small diameter (FIG. 8), a relatively large diameter (FIG. 7) and continuous diameters therebetween, from a minimum radius of the volute inlet 308VI, 310VI to a maximum radius of the volute outlet 308VI, 310VO.

As can be appreciated in FIGS. 9A-C, a generally radial volute grove having a tear-shaped (e.g., a globular or circular shape having a radius at one end that tapers to a smaller radiused position at 308VI) groove 308a is formed in a surface of the first roller 308. It is to be understood that the second roller 310 and its groove 310a are substantially similar to the first roller 308 and its groove 308a.

It will be understood that related radial volute grooves 308a, 310a each have a wrap angle for said grooves 308a, 310a (an angle representing the amount of degrees of the outer surface 308OS, 310OS that is ‘wrapped’ by the radial volute grove) that is between 180° (½ covered) and 360° (full coverage) (e.g. a 180° wrap angle), and preferably between 270° and 360° (e.g., a 90° wrap angle), and more preferably between 315° to 360° (e.g., a 45° wrap angle) and most preferably between 330° to 360° (e.g., a (e.g., a 30° wrap angle). As a non-limiting illustration in FIG. 10A, a wrap angle of approximately 300° (degrees) is illustrated by the groove 308a which leaves approximately 60° (degrees) shown as the ‘remainder from wrap angle’ as the outer surface 308OS having a non-volute region 308NVR. In this way, those of skill in the art will understand that the wrap angle as used herein is the amount of degrees (from a total of 360 degrees) of each roller that is ‘wrapped’ by respective radial volute grooves.

Formation of the radial volute grooves 308a, 310a in respective ones of the rollers 308, 310 may be formed by any convenient means suitable for the material selected. However, it will be understood that radial volute groves 308a, 310a are formed with a hemispherical bottom cross-section having a radius re (radius cross-section) such as with a circular tool bit into the surface of the rollers 308, 310 starting from a proximal end 308p (e.g., the volute inlet 308VI, 310VI) and ending at a distal end 308d (e.g., volute outlet 308VO, 310VO). The radius cross section re of each radial volute 308a, 310a extends from an initial radius cross-sectional minimum rcₘᵢₙ (See FIG. 9C) to a largest radius cross-sectional maximum (see FIG. 9A, 9B). As a result, those of skill in the art will recognize that each respective radial volute curve 80a, 310a has a respective radial volute curve extending from a cross-sectional minimum radius rcₘᵢₙ to a cross-sectional maximum radius rcₘₐₓ, so that continuously therealong each curve there is a hemispherical radius (½ circle or crescent) wrapped (via the respective wrap angles) about each roller 308, 310. As a result, when assembled radial volute curves 308a, 310a, form iris or aperture 306 which is a combination of these groves, and the circular iris or aperture itself having a radius extending from a minimum rₘᵢₙ to a maximum rₘₐₓ. As an example as seen in FIG. 9C there is an intermediate radial cross shown at rcᵢₙₜₑᵣ. Therefore, it will be understood that as respective radial volutes follow their wrap angles, there is an increasing radius of each radial volute groove which correspondingly forms an increasing radius of the thus-formed iris/aperture 306.

As the circular tool bit is pressed deeper into the roller 308, 310, a larger semi-circular groove is formed continuously along the route of the radial volute grove. When the grooves 308a, 310a are positioned abutting next to one another with the similarly dimensioned grooves 308a, 310a positioned in apposition with one another such that the opposing semi-circular regions have equal dimensions, rotation of the rollers 308, 310 relative to one another defines a circular space of the iris 306 having a radius (except where rollers 308, 310 are aligned along their non-volute regions 308NV, 310NV) where there is no groove. By rotating the rollers 308, 310 relative to one another, the circular space of the iris 306 is adjusted in which the circular regions defined closer to the proximal ends of the grooves 308, 310 have smaller diameters than the relatively larger diameters of the circular regions defined closer to the distal ends of the grooves 308, 310. As the rollers 308, 310 rotate relative to one another, the circular shape of the iris 306 may be maintained with only the diameter (and radius) of the formed circle changing as the space defined between the respective grooves 308a, 310a changes.

Having described at least one of the preferred embodiments of the present disclosure with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics. For example, although the grooves 308a, 310a are described as being formed by a series of semi-circular cross-sections radial volutes such that the apposition of the rollers 308, 310 relative to one another forms a circle shape therebetween, other shapes (e.g., ovular shapes) are within the scope and spirit of the present disclosure.

### REFERENCE NUMERALS

100: spotlight
105: fan/vent
110: dowser assembly
115: damper
120: iris
125: boomerang
130: focus knob/handle
135: tilt adjustment
140: pan adjustment
145: yoke
150: base
155: movement handle
160: leveling jacks
200: lamp-house assembly
300: spotlight
301: lighthouse assembly
302: housing
303 iris adjustment system
304: iris adjustment knob
306: iris/aperture
308: first roller
308a: first radial volute groove
310: second roller
310a: second radial volute groove
308VO, 310VO: radial volute groove volute outlet (maximum radius)
308VI, 310VI: radial volute groove volute inlet (minimum radius)
308NVR, 310NVR: non-volute region of each roller
308OS, 310OS: outer surface of each roller
308RA, 310RA: rotational axis of each roller
311: surface
311a: opening
312: gear
314: spring
510: bracket member
y: vertical axis or height
L: lens

What is claimed is:

1. A lighting system, comprising:
a housing including an opening;
a lamp configured to emit a light beam having a first width through the opening; and
an adjustable iris system configured to define the first width of the light beam;
the iris system comprising:
a first roller having a generally cylindrical shape having a first radial volute shaped groove defined in a lateral surface of the first roller;
a second roller having generally cylindrical shape having a second radial volute shaped groove defined in a lateral surface of the second roller;
each respective said first and said second roller being operably secured in said adjustable iris system proximate said opening having said first width;
said respective first and second radial volute shaped grooves each defining an groove cross section continuously extending from an initial radius cross section minimum (rcₘᵢₙ) at a respective volute inlet to a maximum radius cross section (rcₘₐₓ) at a respective volute outlet about a wrap angle of each respective said radial volute shaped groove about respective said first and said second cylinders; and
wherein the first and second radial volute shaped grooves define an aperture space therebetween in said adjustable iris system, wherein the first and second rollers are rotatable relative to one another, and wherein the aperture space has a adjustable second width that changes in response to rotation of the first and second rollers relative to one another along said respective wrap angles of each respective said first and second radial volute shaped groove, and the second adjustable width being less than said first width when the light beam is emitted by the lamp thereby adjusting said iris system.

2. An adjustable iris system, comprising:
a first roller having a generally cylindrical shape and a first radial volute shaped groove defined along a portion of an outer surface of the first roller; and
a second roller in apposition with respect to the first roller, the second roller having a generally cylindrical shape and a second radial volute shaped groove defined along a portion of an outer surface of said second roller;
the first and second rollers are rotatable relative to one another about respective first and second rotational axes;
at least one of said first and second rotational axes of being adjustable relative to said other of said first and second rotational axes so that a distance between said first and second rotational axes may increase during a use while said respective rotational axes remain in parallel; and
wherein the first and second rollers are positioned relative to one another such to define an adjustable space therebetween respective of said first and second radial volute shaped grooves that changes from an initial minimum radius (rₘᵢₙ) to a maximum radius (rₘₐₓ) along a respective first and a second wrap angles for each respective first and second radial volute groove about respective said first and second rotational axes of said the first and second rollers, said adjustable space having a generally circular shape having a free radius that corresponds to a relative rotatable position of the first and second rollers with respect to one another and an inner cross-sectional radius of each respective said first and second radial volute grooves.

3. A lighting kit, comprising:
a housing for mounting an adjustable iris system, the housing including a first support surface and a second opposing support surface; and
the adjustable iris system, comprising:
a first roller having a generally cylindrical shape and a first radial volute shaped groove defined in a lateral surface of the first roller having a first wrap angle about said first roller; and
a second roller in apposition with respect to the first roller, the second roller having a generally cylindrical shape and a second radial volute shaped groove defined in a lateral surface of the second roller and having a second wrap angle about said second roller,
the first and second rollers are rotatable relative to one another,
wherein the first and second rollers are positioned relative to one another in said housing and define a space therebetween the first and second radial volute shaped grooves that is symmetrical with respect a first rotational axis of said first roller and a second rotational axis of said second roller, the space defining circular aperture shape having a diameter that corresponds to a relative rotatable position of the first and second rollers with respect to one another, and
wherein the first roller is mountable widthwise between the first and second support surfaces of the housing, the first roller being fixed with respect to a height dimension of the housing, and wherein the second roller is mountable widthwise between the first and second support surfaces of the housing, the second roller being movable along the height dimension of the housing and being biased toward the first roller during a use thereof.

4. An adjustable aperture system for use in a lighting system, comprising:
an aperture adjustment support having a first support member and a second support member;
said first and second support members opposing each other and defining a space therebetween;
a first roller having a generally cylindrical shape and a first radial volute groove defined in a lateral surface of the first roller; and
a second roller in apposition with respect to the first roller, the second roller having a generally cylindrical shape and a second volute groove defined in a lateral surface of the second roller;
wherein the first and second rollers are rotatable relative to one another, and
wherein the first and second rollers are positioned relative to one another such to define a space between the first and second radial volute grooves that is symmetrical with respect a longitudinally extending axis between the first and second rollers, the space having a circular shape defining a diameter that corresponds to a relative rotatable position of the first and second rollers with respect to one another.
